(19) United States
(12) Patent Application Publication
(10) Pub. No.: US 2021/0132530 A1
(43) Pub. Date: May 6, 2021

(54) FIXING DEVICE AND IMAGE FORMING APPARATUS

(71) Applicant: Oki Data Corporation, Tokyo (JP)

(72) Inventor: Teruo SOEDA, Tokyo (JP)

(73) Assignee: Oki Data Corporation, Tokyo (JP)

(21) Appl. No.: 17/072,551

(22) Filed: Oct. 16, 2020

(30) Foreign Application Priority Data
Oct. 31, 2019 (JP) 2019-198841

(51) Int. Cl. G03G 15/20

(52) U.S. Cl. CPC G03G 15/2053; G03G 2215/2038; G03G 15/2064

(57) ABSTRACT

A fixing device includes a first rotating member, a second rotating member, a heating section, a supporting member, a connector, and a holder. The first rotating member extends in a first direction. The second rotating member extends in the first direction and applies pressure to the first rotating member approximately in a second direction. The second direction is orthogonal to the first direction. The heating section extends in the first direction and heats the first rotating member. The supporting member supports the heating section. The connector is coupled to the heating section and supplies electric power to the heating section. The holder holds the connector. The holder is supported by the supporting member in a state of being movable in the first direction.

### CROSS REFERENCE TO RELATED APPLICATIONS

The present application claims priority from Japanese Patent Application No. 2019-198841 filed on Oct. 31, 2019, the entire contents of which are hereby incorporated by reference.

### BACKGROUND

The technology relates to a fixing device and an image forming apparatus including the fixing device.

For example, as disclosed in Japanese Unexamined Patent Application Publication No. 2006-267234, an image heating device has been proposed that includes a positioning member adapted to position a contact member feeding electric power to an electrode of a heater. The image heating device is configured to allow the positioning member to move in accordance with thermal expansion of the heater. An image forming apparatus including such an image heating device has been also proposed.

### SUMMARY

In an image forming apparatus including an image heating device, i.e., a fixing device, stable feeding of electric power to a heater in the fixing device allows for high-quality image formation.

It is desirable to provide a fixing device that allows for high-quality image formation and an image forming apparatus including the fixing device.

According to one embodiment of the technology, there is provided a fixing device that includes a first rotating member, a second rotating member, a heating section, a supporting member, a connector, and a holder. The first rotating member extends in a first direction. The second rotating member extends in the first direction and applies pressure to the first rotating member approximately in a second direction. The second direction is orthogonal to the first direction. The heating section extends in the first direction and heats the first rotating member. The supporting member supports the heating section. The connector is coupled to the heating section and supplies electric power to the heating section. The holder holds the connector. The holder is supported by the supporting member in a state of being movable in the first direction.

According to one embodiment of the technology, there is provided an image forming apparatus that includes a medium feeding section, an image forming section, and the fixing device described above.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1A is a schematic diagram illustrating an example of an overall configuration of an image forming apparatus according to an example embodiment of the technology.

FIG. 1B is a block diagram schematically illustrating an example of an internal configuration of an image forming apparatus illustrated in FIG. 1A.

FIG. 2A is a perspective view of an example of an appearance of a fixing device illustrated in FIG. 1A.

FIG. 2B is a side view of an example of the appearance of the fixing device illustrated in FIG. 1A.

FIG. 2C is a partial cross-sectional perspective view including an example of a cross-section of a part of the fixing device illustrated in FIG. 1A.

FIG. 2D is an enlarged perspective view of an example of a part of the fixing device illustrated in FIG. 1A.

FIG. 3 is a schematic side view of the fixing device illustrated in FIG. 1A, viewed from upstream thereof.

FIG. 4 is a plan view of an example of a detailed configuration of a heater in the fixing device illustrated in FIG. 1A.

FIG. 5 is a schematic diagram illustrating an example of thermal-expansion displacement of a heater illustrated in FIG. 4.

### DETAILED DESCRIPTION

Hereinafter, some example embodiments of the technology will be described in detail with reference to the drawings. Note that the following description is directed to illustrative examples of the technology and not to be construed as limiting to the technology. Factors including, without limitation, arrangements, dimensions, dimension ratios, numerical values, shapes, materials, components, positions of the components, and how the components are coupled to each other are illustrative only and not to be construed as limiting to the technology. Further, elements in the following example embodiments which are not recited in a most-generic independent claim of the technology are optional and may be provided on an as-needed basis. The drawings are schematic and are not intended to be drawn to scale. Note that the like elements are denoted with the same reference numerals, and any redundant description thereof will not be described in detail.

### 1. Example Embodiments

### [Outline Configuration of Image Forming Apparatus 1]

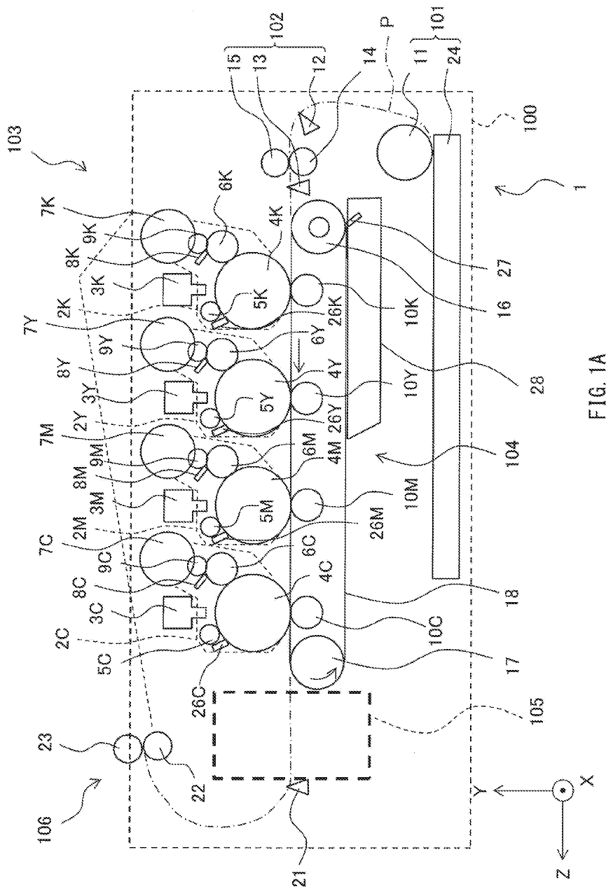

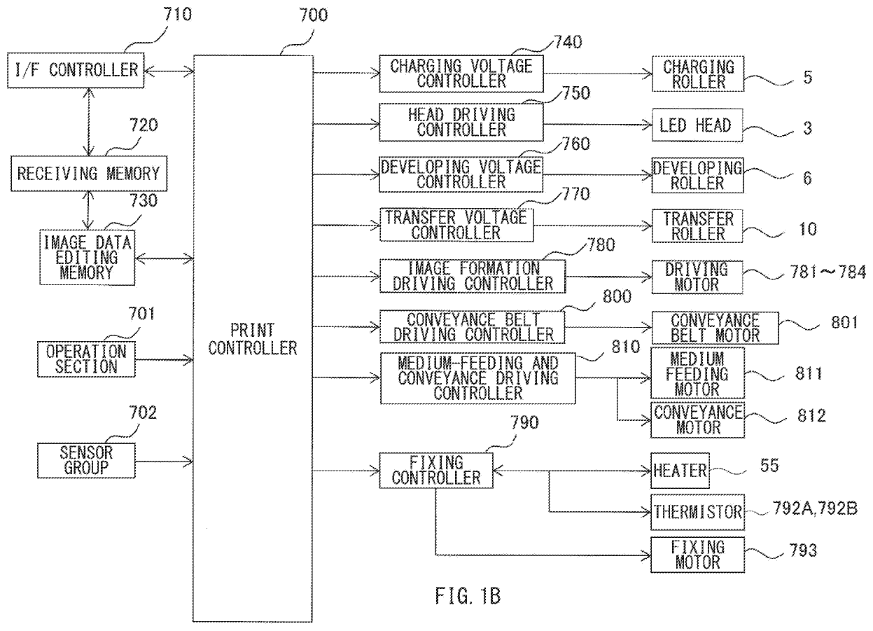

FIG. 1A schematically illustrates an example of an overall configuration of an image forming apparatus 1 that is provided with a fixing device 105 according to an example embodiment of the technology. FIG. 1B is a block diagram corresponding to an example of an internal configuration of the image forming apparatus 1 illustrated in FIG. 1A. The image forming apparatus 1 may be an electrophotographic printer that forms an image on a medium, for example. Non-limiting examples of the image may include a color image. The medium may be also referred to as a print medium or a transfer material. Non-limiting examples of the medium may include a sheet of paper and any type of film. Herein, a direction orthogonal to a conveyance direction of the medium is referred to as a width direction. In FIG. 1A, the width direction is an X-axis direction orthogonal to a paper plane of FIG. 1A. As will be described later, a medium conveying direction, i.e., a direction in which the medium is conveyed inside the fixing device 105, is referred to as a Z-axis direction, and a height direction orthogonal to both the X-axis direction and the Z-axis direction is referred to as a Y-axis direction. Here, the X-axis direction may correspond to a “first direction” in one specific but non-limiting embodiment of the technology. The Y-axis direction may correspond to a “second direction” in one specific but non-limiting embodiment of the technology.

The image forming apparatus 1 may include, for example but not limited to, a medium feeding section 101, a medium conveying section 102, an image forming section 103, a transfer section 104, the fixing device 105, and a discharging section 106 that are disposed, for example, in a housing 100.

### [Medium Feeding Section 101]

The medium feeding section 101 may include, for example but not limited to, a medium cassette 24 and a medium feeding roller 11. The medium cassette 24 may serve as a medium feeding tray and may contain the media. The medium feeding roller 11 may take out the media one by one from the medium cassette 24 and may feed each of the media to the medium conveying section 102.

### [Medium Conveying Section 102]

The medium conveying section 102 may include, for example but not limited to, a position sensor 12, a conveying roller 14, a conveying roller 15, and a position sensor 13 that are disposed, for example, in order from upstream. The position sensors 12 and 13 may each detect a position of the medium traveling along a conveyance path P. The conveying roller 14 and the conveying roller 15 may be paired with each other and may be opposed to each other. The pair of conveying rollers 14 and 15 may convey the medium fed from the medium feeding roller 11 toward the image forming section 103 provided downstream.

### [Image Forming Section 103]

The image forming section 103 may form a toner image which is a non-limiting example of a developer image. The transfer section 104 may transfer, onto the medium, the toner image formed by the image forming section 103. The image forming section 103 may include, for example but not limited to, four image forming units, i.e., image forming units 2K, 2Y, 2M, and 2C. The image forming units 2K, 2Y, 2M, and 2C may respectively include, for example but not limited to, light-emitting diode (LED) heads 3K, 3Y, 3M, and 3C, photosensitive drums 4K, 4Y, 4M, and 4C, charging rollers 5K, 5Y, 5M, and 5C, developing rollers 6K, 6Y, 6M, and 6C, toner tanks 7K, 7Y, 7M, and 7C, developing blades 8K, 8Y, 8M, and 8C, toner-feeding sponge rollers 9K, 9Y, 9M, and 9C, and photosensitive drum blades 26K, 26Y, 26M, and 26C.

The LED heads 3K, 3Y, 3M, and 3C may be opposed to the photosensitive drums 4K, 4Y, 4M, and 4C, respectively. Each of the LED heads 3K, 3Y, 3M, and 3C may perform exposure on a surface of corresponding one of the photosensitive drums 4K, 4Y, 4M, and 4C, thereby forming an electrostatic latent image on the surface of the corresponding one of the photosensitive drums 4K, 4Y, 4M, and 4C.

Each of the photosensitive drums 4K, 4Y, 4M, and 4C may be a columnar member that carries the electrostatic latent image on its surface, i.e., its surficial part. Each of the photosensitive drums 4K, 4Y, 4M, and 4C may include a photoreceptor such as an organic photoreceptor.

Each of the charging rollers 5K, 5Y, 5M, and 5C may electrically charge the surface, i.e., the surficial part, of corresponding one of the photosensitive drums 4K, 4Y, 4M, and 4C. Each of the charging rollers 5K, 5Y, 5M, and 5C may be in contact with a surface, i.e., a peripheral surface, of the corresponding one of the photosensitive drums 4K, 4Y, 4M, and 4C.

Each of the developing rollers 6K, 6Y, 6M, and 6C may carry, on its surface, a toner adapted for development of the electrostatic latent image. Each of the developing rollers 6K, 6Y, 6M, and 6C may be in contact with the surface, i.e., the peripheral surface, of corresponding one of the photosensitive drums 4K, 4Y, 4M, and 4C.

Each of the toner tanks 7K, 7Y, 7M, and 7C may be a container that contains a toner, and may have a toner discharging slot at a lower part of the container.

Each of the developing blades 8K, 8Y, 8M, and 8C may form a layer of a toner on a surface of corresponding one of the developing rollers 6K, 6Y, 6M, and 6C that are rotating. The layer of the toner may also be referred to as a toner layer. Each of the developing blades 8K, 8Y, 8M, and 8C may control or adjust a thickness of the toner layer. Each of the developing blades 8K, 8Y, 8M, and 8C may include a plate-shaped elastic member, and a tip of the plate-shaped elastic member may be disposed in the vicinity of the surface of the corresponding one of the developing rollers 6K, 6Y, 6M, and 6C. The plate-shaped elastic member may include, for example but not limited to, a material such as stainless steel. Non-limiting examples of the plate-shaped elastic member may include a leaf spring.

Each of the toner-feeding sponge rollers 9K, 9Y, 9M, and 9C may feed the toner to corresponding one of the developing rollers 6K, 6Y, 6M, and 6C. Each of the toner-feeding sponge rollers 9K, 9Y, 9M, and 9C may be in contact with a surface, i.e., a peripheral surface, of the corresponding one of the developing rollers 6K, 6Y, 6M, and 6C.

Each of the photosensitive drum blades 26K, 26Y, 26M, and 26C may scrape off and collect the toner remaining on the surface, i.e., the surficial part, of corresponding one of the photosensitive drums 4K, 4Y, 4M, and 4C, thereby cleaning the surface of the corresponding one of the photosensitive drums 4K, 4Y, 4M, and 4C. Each of the photosensitive drum blades 26K, 26Y, 26M, and 26C may be in contact with the surface of the corresponding one of the photosensitive drums 4K, 4Y, 4M, and 4C from a counter direction. In other words, each of the photosensitive drum blades 26K, 26Y, 26M, and 26C may protrude in a direction opposite to a rotation direction of the corresponding one of the photosensitive drums 4K, 4Y, 4M, and 4C. Each of the photosensitive drum blades 26K, 26Y, 26M, and 26C may include, for example but not limited to, an elastic member including a material such as polyurethane rubber.

### [Transfer Section 104]

The transfer section 104 may include, for example but not limited to, a conveyance belt 18, a driving roller 17, a driven roller 16, transferring rollers 10K, 10Y, 10M, and 10C, a belt blade 27, and a waste toner box 28. The driving roller 17 may drive the conveyance belt 18. The driven roller 16 may be driven in accordance with the driving roller 17. The transferring rollers 10K, 10Y, 10M, and 10C may be opposed to the photosensitive drums 4K, 4Y, 4M, and 4C, respectively, with the conveyance belt 18 therebetween.

The conveyance belt 18 may be an endless elastic belt including, for example but not limited to, a resin material such as polyimide resin. The conveyance belt 18 may lie on the driving roller 17, the driven roller 16, and the transferring rollers 10K, 10Y, 10M, and 10C while being stretched. The conveyance belt 18 may circularly rotate in a direction indicated by an arrow in FIG. 1A. The driving roller 17 may drive the conveyance belt 18 with use of driving force supplied from a conveyance belt motor 801 which will be described later. Each of the transferring rollers 10K, 10Y, 10M, and 10C may electrostatically transfer, onto the medium, the toner image formed by corresponding one of the image forming units 2K, 2Y, 2M, and 2C while conveying the medium in the conveyance direction. Each of the transferring rollers 10K, 10Y, 10M, and 10C may include, for example but not limited to, a foamable electrically-semiconductive elastic rubber material. Each of the driving roller 17, the driven roller 16, and the transferring rollers 10K, 10Y, 10M, and 10C may be a substantially-columnar member that extends in a lateral direction, and may be rotatable. The lateral direction refers to a direction orthogonal to the paper plane of FIG. 1A. The belt blade 27 may scrape off the waste toner remaining on a surface of the conveyance belt 18, thereby cleaning the surface of the conveyance belt 18. The waste toner box 28 may store the waste toner scraped off and collected by the belt blade 27.

### [Fixing Device 105]

The fixing device 105 may apply heat and pressure to the toner image transferred on the medium conveyed from the transfer section 104, and may thereby fix the toner image to the medium. The fixing device 105 may include, for example but not limited to, a heater 53, thermistors 792A and 792B, and a fixing motor 793. Details of the fixing device 105 will be described later.

### [Discharging Section 106]

The discharging section 106 may include, for example but not limited to, a position sensor 21 and discharging rollers 22 and 23 opposed to each other. The position sensor 21 may detect a position of the medium traveling along the conveyance path P after being discharged from the fixing device 105. The discharging rollers 22 and 23 may discharge the medium, discharged from the fixing device 105, further to the outside.

As illustrated in FIG. 1B, the image forming apparatus 1 may include, for example but not limited to, a print controller 700, an interface (I/F) controller 710, a receiving memory 720, an image data editing memory 730, an operation section 701, and a sensor group 702. The image forming apparatus 1 may further include, for example but not limited to, a charging voltage controller 740, a head driving controller 750, a developing voltage controller 760, a transfer voltage controller 770, an image formation driving controller 780, a fixing controller 790, a conveyance belt driving controller 800, and a medium-feeding and conveyance driving controller 810 that each receive a command from the print controller 700.

The print controller 700 may include, for example but not limited to, a microprocessor, a read-only memory (ROM), a random-access memory (RAM), and an input-output port. The print controller 700 may execute, for example, a predetermined program and may thereby control general processing operation of the image forming apparatus 1. For example, the print controller 700 may receive print data, a control command, or any other data from the I/F controller 710, and may generally control the charging voltage controller 740, the head driving controller 750, the developing voltage controller 760, the transfer voltage controller 770, the image formation driving controller 780, the fixing controller 790, the conveyance belt driving controller 800, and the medium-feeding and conveyance driving controller 810, thereby causing printing operation to be performed.

The I/F controller 710 may receive, for example, print data, a control command, or any other data from an external device such as a personal computer (PC), or may transmit a signal related to a state of the image forming apparatus 1.

The receiving memory 720 may temporarily hold the print data received from the external device such as the PC via the I/F controller 710.

The image data editing memory 730 may receive the print data stored in the receiving memory 720 and may hold image data resulting from editing of the print data.

The operation section 701 may include, for example but not limited to, an LED lamp and an input section. The LED lamp may be adapted to display information such as the state of the image forming apparatus 1, for example. The input section may be provided for a user to give an instruction to the image forming apparatus 1. Non-limiting examples of the input section may include a button and a touch panel.

The sensor group 702 may include various sensors monitoring an operating state of the image forming apparatus 1. Non-limiting examples of such various sensors may include: the position sensors 12, 13, and 21 that detect the position of the medium; a temperature sensor 29 that detects a temperature inside the image forming apparatus 1; and a printing density sensor 30.

The charging voltage controller 740 may apply a charging voltage to each of the charging rollers 5K, 5Y, 5M, and 5C on the basis of an instruction from the print controller 700, and may perform a control to electrically charge the surface of each of the photosensitive drums 4K, 4Y, 4M, and 4C.

The head driving controller 750 may control exposure operation of the LED heads 3K, 3Y, 3M, and 3C on the basis of the image data stored in the image data editing memory 730.

The developing voltage controller 760 may apply a developing voltage to each of the developing rollers 6K, 6Y, 6M, and 6C on the basis of an instruction given from the print controller 700, and may so perform a control as to develop the toner on the electrostatic latent image formed on the surface of corresponding one of the photosensitive drums 4K, 4Y, 4M, and 4C.

The transfer voltage controller 770 may apply a transfer voltage to each of the transferring rollers 10K, 10Y, 10M, and 10C on the basis of an instruction given from the print controller 700, and may so perform a control as to transfer the toner image onto the medium.

The image formation driving controller 780 may perform a driving control of each of driving motors 781 to 784 on the basis of an instruction given from the print controller 700. The driving motors 781 to 784 may drive the photosensitive drums 4K, 4Y, 4M, and 4C, the charging rollers 5K, 5Y, 5M, and 5C, and the developing rollers 6K, 6Y, 6M, and 6C to rotate.

The fixing controller 790 may control fixing operation of the fixing device 105 on the basis of an instruction given from the print controller 700. For example, the fixing controller 790 may control a voltage applied to the heater 53. The fixing controller 790 may perform an ON-OFF control of the voltage applied to the heater 53, on the basis of a temperature of the fixing device 105. The temperature of the fixing device 105 may be measured by the thermistors 792A and 792B. The fixing controller 790 may further control operation of the fixing motor 793 on the basis of the temperature of the fixing device 105 measured by the thermistors 792A and 792B.

The conveyance belt driving controller 800 may control operation of the conveyance belt motor 801 provided in the image forming apparatus 1 on the basis of an instruction given from the print controller 700. The conveyance belt motor 801 may drive the conveyance belt 18.

The medium-feeding and conveyance driving controller 810 may control operation of a medium feeding motor 811 and a conveyance motor 812 provided in the image forming apparatus 1 on the basis of an instruction given from the print controller 700.

### [Configuration of Fixing Device 105]

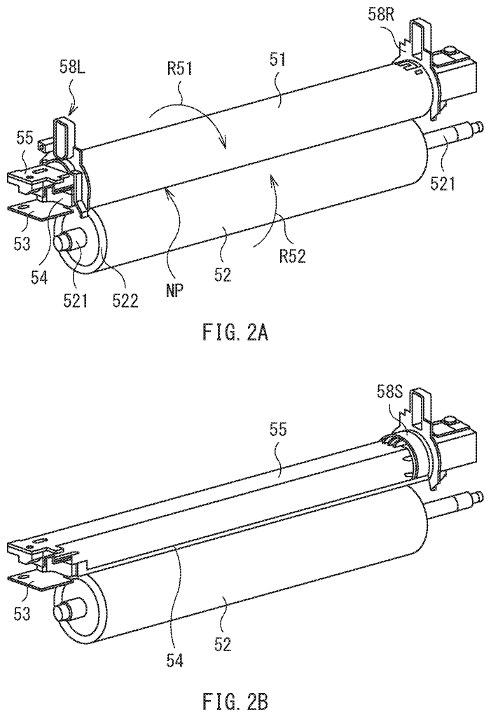

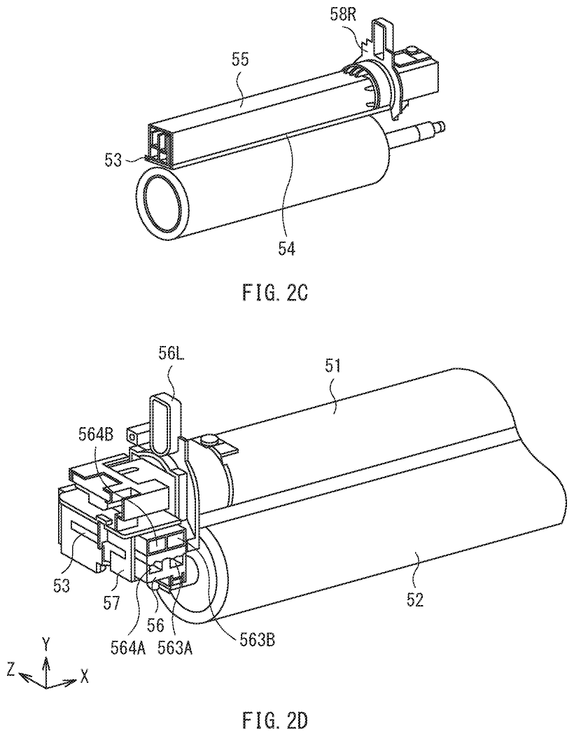

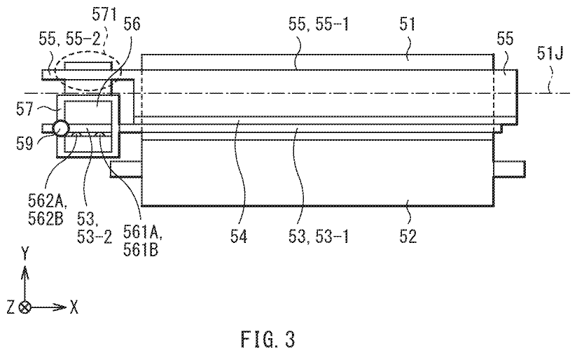

A detailed configuration of the fixing device 105 is described below with reference to FIGS. 2A to 2D and 3. FIG. 2A is a perspective view of an appearance of the fixing device 105, viewed from the upstream of the conveyance direction of the medium. FIG. 2B is a perspective view of an appearance of a part of the fixing device 105 with some components illustrated in FIG. 2A being removed. FIG. 2C is a partial cross-sectional perspective view of the fixing device 105 including a cross-section of a part of the fixing device 105 illustrated in FIG. 2B. FIG. 2D is an enlarged perspective view of a part of the fixing device 105. FIG. 3 is a schematic side view of the fixing device 105, viewed from the upstream thereof.

The fixing device 105 may include, for example but not limited to, a fixing belt 51, a pressure-applying roller 52, the heater 53, a heater holder 54, a plate holder 55, a connector 56, a connector holder 57, and flanges 58 (i.e., flanges 58L and 58R).

### [Fixing Belt 51]

The fixing belt 51 may be an endless elastic belt having a cylindrical shape that includes an inner circumferential surface and an outer circumferential surface. In one non-limiting example, the fixing belt 51 may include a resin material such as polyimide resin. In another non-limiting example, the fixing belt 51 may include a metal base of metal such as stainless steel and a material such as silicone rubber provided on the metal base. The fixing belt 51 may be configured to circularly rotate in a direction indicated by an arrow R51 (see FIG. 2A) about an axis 51J (see FIG. 3). The axis 51J may extend in a width direction of the fixing belt 51. Upon circularly rotating, the fixing belt 51 may slide along an outer circumferential surface 58S (see FIG. 2B) of each of the paired flanges 58L and 58R provided on respective ends in the width direction. The fixing belt 51 may have an internal space that is surrounded by the fixing belt 51 and extends in the width direction. Provided in the internal space may be the heater 53. The fixing belt 51 may lie on the heater 53 and any other stretching member, while being stretched. The fixing belt 51 may be heated by the heater 53. The outer circumferential surface of the fixing belt 51 may be so biased as to be in contact with an outer circumferential surface of the pressure-applying roller 52 opposed to the outer circumferential surface of the fixing belt 51 in the Y-axis direction, thereby providing a nip part NP that extends on an X-Z plane, as illustrated in FIG. 2B. In this example, the fixing belt 51 may move in a +Z direction in the vicinity of the nip part NP. In addition to the heater 53, the heater holder 54 and the plate holder 55 may also be disposed in the internal space of the fixing belt 51, i.e., in the space surrounded by the fixing belt 51. The fixing belt 51 may correspond to a “first rotating member” in one specific but non-limiting embodiment of the technology.

### [Pressure-Applying Roller 52]

The pressure-applying roller 52 may be a rotating member that has a columnar shape or a cylindrical shape extending in the width direction. The pressure-applying roller 52 may be configured to rotate in a direction indicated by an arrow R52 (see FIG. 2B) around an axis 52J, while being so biased toward the fixing belt 51 as to sandwich the medium between the fixing belt 51 and the pressure-applying roller 52. The direction indicated by the arrow R52 may be opposite to the direction indicated by the arrow R51. The axis 52J may extend along the axis 51J. The pressure-applying roller 52 may include a shaft 521 and an elastic layer 522 that surrounds the shaft 521. The shaft 521 may include a rigid material such as a metal pipe and may extend in the width direction, for example. The shaft 521 may be rotatably supported, in the vicinity of both ends of the shaft 521, by a base fixed to the housing 100 of image forming apparatus 1. The shaft 521 may include a material such as stainless steel. The elastic layer 522 may include, for example, a foamed body including a material such as a sponge-like silicone having a plurality of air bubbles. In one example embodiment, the elastic layer 522 may have thermal conductivity lower than that of the shaft 521. As illustrated in FIG. 2A, the pressure-applying roller 52 may be in contact with the outer circumferential surface of the fixing belt 51, thereby providing the nip part NP. In this example, the pressure-applying roller 52 may move in the +Z direction in the vicinity of the nip part NP. The heater 53 may be provided at a position opposed to the pressure-applying roller 52 with the fixing belt 51 therebetween.

The pressure-applying roller 52 may correspond to a “second rotating member” in one specific but non-limiting embodiment of the technology.

### [Heater 53]

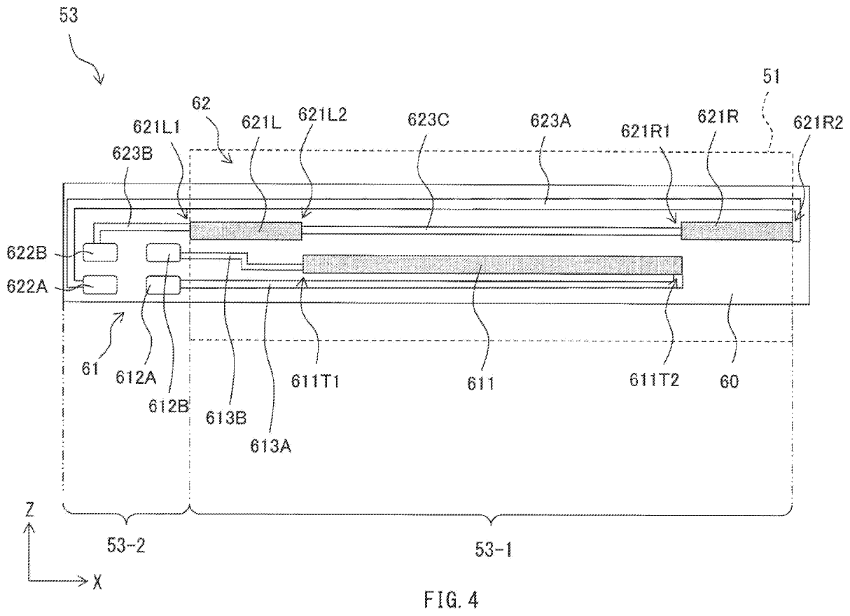

The heater 53 may extend in the width direction as with the fixing belt 51. The heater 53 may heat the fixing belt 51 and may include a heat generating body controlled by the fixing controller 790. In one example embodiment, the heater 53 may be positioned in the vicinity of the nip part NP that is a contact part at which the fixing belt 51 and the pressure-applying roller 52 are in contact with each other. As illustrated in FIG. 4, the heater 53 may include: a surrounded part 53-1 which is in a state of being inserted in the internal space of the fixing belt 51; and an exposed part 53-2 which extends in the width direction and is present outside the fixing belt 51. The surrounded part 53-1 of the heater 53 may be opposed to the inner circumferential surface of the fixing belt 51. Note that FIG. 4 is a plan view of a detailed configuration of the heater 53 in the fixing device 105. As illustrated in FIG. 4, the heater 53 may include a first heat generating section 61 and a second heat generating section 62 disposed on a substrate 60 that has a flat shape extending in the width direction. The first heat generating section 61 may include a first heat generating body 611. The second heat generating section 62 may include second heat generating bodies 621L and 621R. The first heat generating section 61 and the second heat generating section 62 may be separated away from each other, for example, in the Z-axis direction.

The first heat generating section 61 may include, for example but not limited to, one first heat generating body 611, electrodes 612A and 612B, and wirings 613A and 613B. The first heat generating body 611 may be so disposed at a middle part, in the width direction, of the surrounded part 53-1 of the heater 53 as to extend in the width direction. The electrodes 612A and 612B may be provided in the exposed part 53-2. The wiring 613A may be so disposed as to couple a first end 611T1 of the first heat generating body 611 and the electrode 612A to each other, for example. The wiring 613B may be so disposed as to couple a second end 611T2 of the first heat generating body 611 and the electrode 612B to each other, for example. Therefore, when the first heat generating section 61 is energized, i.e., when a current flows between the electrode 612A and the electrode 612B, the first heat generating body 611 may generate heat thereby. As a result, the middle part of the fixing belt 51 in the width direction may be heated.

The second heat generating section 62 may include, for example but not limited to, two second heat generating bodies 621L and 621R, electrodes 622A and 622B, and wirings 623A and 623B. The second heat generating bodies 621L and 621R may be so disposed at respective ends, in the width direction, of the surrounded part 53-1 of the heater 53 as to extend in the width direction. The electrodes 622A and 622B may be provided in the exposed part 53-2. The wiring 623A may be so disposed as to couple a second end 621R2 of the second heat generating body 621R and the electrode 622A to each other, for example. The wiring 623B may be so disposed as to couple a first end 621L1 of the second heat generating body 621L and the electrode 622B to each other, for example. The wiring 623C may be so disposed as to couple the second end 621L2 of the second heat generating body 621L and the first end 621R1 of the second heat generating body 621R to each other. Therefore, when the second heat generating section 62 is energized, i.e., when a current flows between the electrode 622A and the electrode 622B, the second heat generating bodies 621L and 621R may generate heat thereby. As a result, both of the ends of the fixing belt 51 in the width direction may be heated.

The first heat generating body 611 and the second heat generating bodies 621L and 621R may each be, for example, a resistive wire that generates heat in response to supply of a current. The first heat generating body 611 and the second heat generating bodies 621L and 621R may each include, for example, a high-resistance metal material such as nickel-chromium alloy (NiCr). In one example embodiment, the electrodes 612A and 612B, the electrodes 622A and 622B, the wirings 613A and 613B, and the wirings 623A and 623B may each include a highly-electrically-conductive non-magnetic metal material such as Au (gold), Ag (silver), Cu (copper), Ta (tantalum), or Al (aluminum).

The heater 53 may correspond to a “heating section” in one specific but non-limiting embodiment of the technology. The first heat generating body 611 may each correspond to a “first heat generating body” in one specific but non-limiting embodiment of the technology. The second heat generating bodies 621L and 621R may correspond to a “second heat generating body” in one specific but non-limiting embodiment of the technology. The surrounded part 53-1 may correspond to a “first surrounded part” in one specific but non-limiting embodiment of the technology. The exposed part 53-2 may correspond to a “first exposed part” in one specific but non-limiting embodiment of the technology.

### [Heater Holder 54]

The heater holder 54 may be a plate-shaped member that holds the heater 53, and may extend in the width direction. The heater holder 54 may be fixed to a surface, of the surrounded part 53-1 of the heater 53, opposite to a surface opposed to an inner surface of the fixing belt 51. In one example embodiment, the heater holder 54 may include a material having low thermal conductivity such as resin in order to prevent the heat of the heater 53 from being released to the outside via another member such as the plate holder 55.

### [Plate Holder 55]

The plate holder 55 may support the heater 53 with the heater holder 54 therebetween, and may rotatably support the fixing belt 51. The plate holder 55 may be a highly-rigid member including a metal material such as stainless steel, and may have rigidity higher than at least that of the heater 53. As illustrated in FIG. 3, the plate holder 55 may include: a surrounded part 55-1 which is provided in the internal space of the fixing belt 51; and an exposed part 55-2 which extends in the width direction and is present outside the fixing belt 51. The surrounded part 55-1 may be fixed to the heater 53 with the heater holder 54 therebetween. In one example embodiment, however, the heater 53 and the plate holder 55 may be fixed to each other at a single point in the width direction, for example, at a reference point BP which will be described later. The exposed part 55-2 may be so opposed to the exposed part 53-2 of the heater 53 as to be separated away from the exposed part 53-2.

The plate holder 55 may correspond to a “supporting member” in one specific but non-limiting embodiment of the technology. The surrounded part 55-1 may correspond to a “second surrounded part” in one specific but non-limiting embodiment of the technology. The exposed part 55-2 may correspond to a “second exposed part” in one specific but non-limiting embodiment of the technology.

### [Connector 56]

Coupled to the exposed part 53-2 of the heater 53 may be the connector 56. The connector 56 may be a coupling part that supplies electric power to the heater 53. The connector 56 may include electrodes 561A and 561B and electrodes 562A and 562B at positions opposed to the electrodes 612A and 612B and the electrodes 622A and 622B of the heater 53, respectively. The connector 56 may be so attached to the heater 53 as to sandwich the exposed part 53-2 in a height direction (i.e., the Y-axis direction). This may cause the electrodes 612A and 612B and the electrodes 622A and 622B of the heater 53 to come into contact with the electrodes 561A and 561B and the electrodes 562A and 562B of the connector 56, respectively. As illustrated in FIG. 2D, the connector 56 may include sockets 563A and 563B and sockets 564A and 564B that are each configured to be coupled to a power-feed line that supplies electric power to the heater 53. The electrodes 561A and 561B and the electrodes 562A and 562B may be in continuity with the sockets 563A and 563B and the sockets 564A and 564B, respectively, inside the connector 56.

The connector 56 may correspond to a “connector” in one specific but non-limiting embodiment of the technology. The sockets 563A and 563B may correspond to a “first coupling part” in one specific but non-limiting embodiment of the technology. The sockets 564A and 564B may correspond to a “second coupling part” in one specific but non-limiting embodiment of the technology.

### [Connector Holder 57]

The connector holder 57 may hold the connector 56. The connector holder 57 may be supported by the plate holder 55 in a state of being movable in the width direction. The connector holder 57 may include an insertion part 571 that has a cavity extending in the width direction. Inserted in the cavity of the insertion part 571 may be a part of the exposed part 55-2 of the plate holder 55. Accordingly, the plate holder 55 may be so provided as to be freely movable in the width direction with respect to the connector holder 57. However, the plate holder 55 may be prevented from moving in the height direction (the Y-axis direction) with respect to the connector holder 57. The part, of the exposed part 55-2, that is in the state of being inserted in the cavity of the insertion part 571 may have a size, on a cross-section orthogonal to the X-axis direction, equal to or smaller than a size of the cavity. That is, for example, the part, of the exposed part 55-2, that is in the state of being inserted in the cavity of the insertion part 571 may have an area in a Y-Z cross-section that is equal to or smaller than the area in the Y-Z cross-section of the cavity of the insertion part 571. The Y-Z cross-section may be orthogonal to the width direction. A dimension, in the Y-Z cross-section, of the part, of the exposed part 55-2, that is in the state of being inserted in the cavity of the insertion part 571 may be smaller than a dimension of the cavity of the insertion part 571 in the Y-Z cross-section, for example, within a range from 0.1 mm to 0.4 mm both inclusive. FIG. 2D illustrates an example case where the cavity of the insertion part 571 may fully extend through the insertion part 571 in the width direction. However, according to the example embodiment, it may be sufficient that the cavity of the insertion part 571 is opened on a surface, of the connector holder 57, opposed to the fixing belt 51 in the width direction. Therefore, the cavity of the insertion part 571 may not need to be opened on a surface opposite to the fixing belt 51 in the width direction. It may be sufficient that a part of the exposed part 55-2 is movable inside the cavity of the insertion part 571 also in this case. The connector holder 57 may correspond to a “holder” in one specific but non-limiting embodiment of the technology.

As illustrated in FIGS. 2D and 3, the connector holder 57 may so hold the connector 56 as to surround the connector 56. The connector 56 may hold a part of the exposed part 53-2 of the heater 53. The connector holder 57 may be joined to the heater 53, for example, at a joint 59. The joint 59 may be positioned, for example, in the vicinity of the connector 56. The term “join” and its variants herein may refer to, for example, engaging with a screw, attaching through bonding, fitting by fitting a protrusion into a depression, and any other way of joining. In one example embodiment, the connector holder 57 may be biased toward the heater 53 by means of a biasing member such as a spring, whereby a mutual positional relationship between the heater 53 and the connector holder 57 may be kept within a certain range. With such a structure, the connector 56 may be so held by the connector holder 57 that the connector 56 is pressed against a part of the exposed part 53-2 of the heater 53. As a result, the contact between the electrode 612A and the electrode 561A, the contact between the electrode 612B and the electrode 561B, the contact between the electrode 622A and the electrode 562A, and the contact between the electrode 622B and the electrode 562B may be maintained stably.

In one example embodiment, the heater 53 and the connector holder 57 may be fixed to each other at the single joint 59. One reason for this is that, if the heater 53 and the connector holder 57 are fixed to each other at two or more joints, thermal expansion of the heater 53 at the time of energizing of the heater 53 may cause a stress to be exerted on the heater 53 and the connector holder 57. Such a stress may be derived from a difference in thermal expansion rate between the heater 53 and the connector holder 57. This can deteriorate the heater 53 and the connector holder 57 more easily. In a case where the heater 53 and the connector holder 57 are fixed to each other at the single joint 59, the heater 53 and the connector holder 57 may each be displaced in accordance with its own thermal expansion rate, whereby exertion of the stress is avoided.

In one example embodiment, the fixing device 105 may further include a temperature detector 792. The temperature detector 792 may include a thermistor 792A and a thermistor 792B. The thermistor 792A may detect, for example, a temperature of a middle part, in the width direction, of a surface of the pressure-applying roller 52. The thermistor 792B may detect, for example, a temperature of both ends, in the width direction, of the surface of the pressure-applying roller 52.

### Example Workings and Example Effects

### [A. Basic Operation]

The image forming apparatus 1 may transfer the toner image onto the medium as follows, for example.

For example, as illustrated in FIG. 1A, first, the medium contained in the medium cassette 24 may be picked up one by one from the top by the medium feeding roller 11. The medium picked up may be fed toward the medium conveying section 102 positioned downstream. The medium fed by the medium feeding roller 11 may be thereafter conveyed toward the image forming section 103 and the transfer section 104 positioned downstream while a skew of the medium is corrected by the medium conveying section 102. A toner image may be transferred onto the medium in the image forming section 103 and the transfer section 104 as follows, for example.

When the print controller 700 of the operating image forming apparatus 1 receives the print image data and a printing command from the external device such as the PC via the I/F controller 710, the print controller 700 may start printing operation of the print image data on the basis of the printing command in association with a controller such as the image formation driving controller 780.

The image formation driving controller 780 may drive the driving motors 781 to 784 and may thereby cause the photosensitive drums 4K, 4Y, 4M, and 4C to rotate in a predetermined direction at a constant speed. When the photosensitive drums 4K, 4Y, 4M, and 4C rotate, motive power of the rotation may be transmitted, via a driving transmitting section such as a gear string, to each of the toner-feeding sponge rollers 9K, 9Y, 9M, and 9C, the developing rollers 6K, 6Y, 6M, and 6C, and the charging rollers 5K, 5Y, 5M, and 5C. As a result, each of the toner-feeding sponge rollers 9K, 9Y, 9M, and 9C, the developing rollers 6K, 6Y, 6M, and 6C, and the charging rollers 5K, 5Y, 5M, and 5C may rotate in a predetermined direction.

On the basis of a command from the print controller 700, the charging voltage controller 740 may apply a predetermined voltage to each of the charging rollers 5K, 5Y, 5M, and 5C, and may thereby electrically charge the surfaces of the photosensitive drums 4K, 4Y, 4M, and 4C uniformly.

Thereafter, the head driving controller 750 may activate the LED heads 3K, 3Y, 3M, and 3C, and may thereby apply light corresponding to the print image based on an image signal to the photosensitive drums 4K, 4Y, 4M, and 4C, forming electrostatic latent images on the surfaces of the photosensitive drums 4K, 4Y, 4M, and 4C. Further, the toners may be fed from the toner tanks 7K, 7Y, 7M, and 7C to the toner-feeding sponge rollers 9K, 9Y, 9M, and 9C, respectively. The toners may be carried by the toner-feeding sponge rollers 9K, 9Y, 9M, and 9C and may move to the vicinity of the developing rollers 6K, 6Y, 6M, and 6C in accordance with the rotation of the toner-feeding sponge rollers 9K, 9Y, 9M, and 9C. On this occasion, the toners may be, for example, charged negatively as a result of potential differences between potentials of the developing rollers 6K, 6Y, 6M, and 6C and potentials of the toner-feeding sponge rollers 9K, 9Y, 9M, and 9C and may be fed to the developing rollers 6K, 6Y, 6M, and 6C, respectively. The toners fed to the developing rollers 6K, 6Y, 6M, and 6C may become toner layers with predetermined thicknesses controlled by the developing blades 8K, 8Y, 8M, and 8C, respectively.

The toner layers on the developing rollers 6K, 6Y, 6M, and 6C may be developed in accordance with the electrostatic latent images formed on the surfaces of the photosensitive drums 4K, 4Y, 4M, and 4C, respectively. Toner images may be thereby formed on the respective photosensitive drums 4K, 4Y, 4M, and 4C. The toner images may be transferred onto the medium by means of electric fields between the photosensitive drums 4K, 4Y, 4M, and 4C and the transferring rollers 10K, 10Y, 10M, and 10C. The transferring rollers 10K, 10Y, 10M, and 10C may be opposed to the photosensitive drums 4K, 4Y, 4M, and 4C, respectively, and may receive a predetermined voltage from the transfer voltage controller 770.

Thereafter, on the basis of the control performed by the fixing controller 790, the fixing device 105 may apply heat and pressure to the toner images transferred on the medium. The toner images may be thereby fixed to the medium. Thereafter, the medium with the fixed toner images may be discharged to the outside by the discharging section 106. A small amount of toner which has not been transferred onto the medium may possibly remain on the photosensitive drums 4K, 4Y, 4M, and 4C in some cases. In this case, the remaining toner may be removed by the photosensitive drum blades 26K, 26Y, 26M, and 26C. This allows for continuous use of the photosensitive drums 4K, 4Y, 4M, and 4C. [B. Operation of Fixing Device 105] The fixing device 105 may be controlled by the fixing controller 790, and may thereby perform a process of fixing the toner image to the medium, on the basis of an instruction given from the print controller 700. For example, in accordance with the control performed by the fixing controller 790, while a current is supplied to the heater 53 and the fixing belt 51 may be thereby heated, the fixing motor 793 may be activated and may thereby cause the pressure-applying roller 52 to rotate. The fixing belt 51 that is in contact with the pressure-applying roller 52 at the nip part NP may also start to rotate in accordance with the rotation of the pressure-applying roller 52.

In the fixing device 105, the fixing controller 790 may control supply of electric power to the first heat generating section 61 and the second heat generating section 62 of the heater 53 on the basis of a surface temperature of the pressure-applying roller 52 detected by the thermistors 792A and 792B. In a case where the medium on which printing is to be performed has a relatively-small width dimension and the medium therefore comes into contact only with the middle part of the fixing belt 51, it may be sufficient to heat only the middle part of the fixing belt 51. In this case, it may be sufficient to energize only the first heat generating section 61 including the first heat generating body 611. In contrast, in a case where the medium on which printing is to be performed has a relatively-large width dimension and the medium therefore comes into contact not only with the middle part of the fixing belt 51 but also with the both ends of the fixing belt 51, it may be necessary to heat an entire surface of the fixing belt 51. In this case, both the first heat generating section 61 and the second heat generating section 62 may be energized.

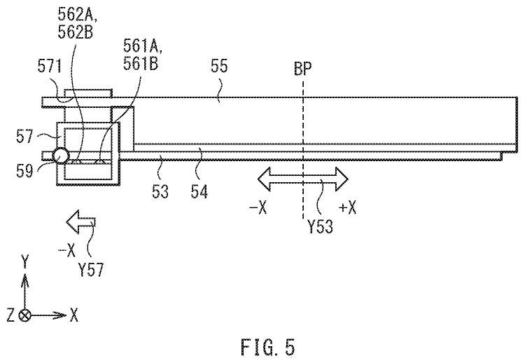

In the fixing device 105, energizing of the heater 53 based on the control performed by the fixing controller 790 can sometimes result in thermal expansion of the heater 53 itself. Because the heater 53 has a shape that is longer in the width direction (the X-axis direction), the heater 53 can thermally expand in the width direction upon being energized, as illustrated in FIG. 5. FIG. 5 schematically illustrates displacement of the heater 53 resulting from the thermal expansion of the heater 53 and displacement of a member around the heater 53 accompanying the thermal expansion of the heater 53. When the heater 53 is energized and the first heat generating body 611 and the second heat generating bodies 621L and 621R thereby generate heat, a part on right side of the reference point BP on the paper plane may thermally expand and may thereby move in the +X direction, and a part on left side of the reference point BP on the paper plane may thermally expand and may thereby move in the −X direction. Here, the reference point may refer to a point, of the heater 53, that is so fixed as not to move with respect to the housing 100, for example. Upon the thermal expansion described above, the connector holder 57 may move in the −X direction in accordance with the displacement of the heater 53 as indicated by an arrow Y57, because the connector holder 57 may be joined to the heater 53 at the joint 59. Although the connector holder 57 may be supported by the plate holder 55, the connector holder 57 may not be limited by the plate holder 55 in its movement in the width direction. For this reason, the connector holder 57, the connector 56 held by the connector holder 57, and the heater 53 held by the connector holder 57 may not receive the stress from a member such as the plate holder 55. Further, in a case where the heater 53 and the heater holder 54 are fixed to each other at a single point in the width direction, generation of a stress between the heater 53 and the heater holder 54 is suppressed. Similarly, in a case where the heater holder 54 and the plate holder 55 are fixed to each other at a single point in the width direction, generation of a stress between the heater holder 54 and the plate holder 55 is suppressed.

Moreover, the connector holder 57 may be supported by the plate holder 55. Therefore, the weight of the connector holder 57 may be applied mainly on the plate holder 55. This may help to sufficiently reduce the weight of the connector holder 57 applied on the heater 53. Further, in a case where the plate holder 55 includes a highly-rigid material such as stainless steel, the weight of the connector holder 57 applied on the heater 53 can be substantially negligible.

### C. Example Effects

As described above, in the fixing device 105 and the image forming apparatus 1 according to the example embodiments of the technology, the connector 56 configured to supply electric power to the heater 53 may be held by the connector holder 57, and the plate holder 55 supporting the heater 53 may be held by the connector holder 57 in a state of being movable in the width direction. Therefore, the heater 53 and the connector 56 are kept being favorably coupled to each other also in a case where the heater 53 expands or contracts as a result of heat generation of the heater 53 itself. In another case where the fixing device 105 receives unintended vibration or impact from outside, the heater 53 and the connector 56 are also kept being favorably coupled to each other. Accordingly, it is possible to avoid a poor contact, thereby improving operation reliability.

Moreover, the fixing device 105 may involve a structure in which the connector holder 57 is supported in the height direction (the Y-axis direction) by the plate holder 55 having high rigidity. It is therefore possible to sufficiently reduce the weight of the connector holder 57 applied on the heater 53 having relatively low strength. For example, according to the example embodiment, the heater 53 may be provided with two systems of heater circuits, and may be provided with the connector 56 and the connector holder 57 that are relatively large in size. Therefore, the structure in which the plate holder 55 having rigidity higher than that of the heater 53 supports the connector holder 57 is effective in preventing bowing, bending, or damage of the heater 53 resulting from the weight of the connector 56 or the weight of the connector holder 57. Accordingly, it is possible to obtain higher operation reliability.

In a case where the heater 53 and the connector holder 57 are fixed to each other at the single joint 59, the stress generated between the heater 53 and the connector holder 57 is further reduced. Accordingly, it is possible to further improve the operation reliability.

Moreover, according to the example embodiment, the heater 53 may include the first heat generating section 61 and the second heat generating section 62, and the first heat generating section 61 and the second heat generating section 62 may be able to perform heating independently of each other. This allows for an ON-OFF control of the first heat generating section 61 and the second heat generating section 62 based on the width dimension of the medium. This is advantageous in reduction in electric power consumption. This also helps avoiding overheating of a part, of the fixing belt 51, not in contact with the medium, when printing is performed on the medium having a small width dimension. Examples of the part, of the fixing belt 51, not in contact with the medium may include both end parts of the fixing belt 51 in the width direction. Accordingly, it is possible to more stably control the temperature of the nip part of the fixing belt 51 and the pressure-applying roller 52.

Moreover, according to the example embodiment, in a case where the heater 53 and the plate holder 55 are fixed at a single point in the width direction, it is possible to further reduce the stress between the heater 53 and the plate holder 55, thereby further improving the operation reliability.

### 2. Modifications

The technology has been described above referring to some example embodiments; however, the technology is not limited thereto and may be modified in a variety of ways. For example, description has been given above of the example embodiment of the image forming apparatus forming a color image; however, the technology is not limited thereto. In one example embodiment, the image forming apparatus may transfer, for example, only a black toner image, and may thereby form a monochrome image. Further, the description has been given above of the example embodiment of the image forming apparatus of a primary transfer method, i.e., a direct transfer method; however, the technology is not limited thereto. One example embodiment of the technology is also applicable to a secondary transfer method.

Moreover, although, the pressure-applying roller 52 may be used as the second rotating member providing the nip part together with the fixing belt 51 serving as the first rotating member according to the example embodiment described above, the technology is not limited to this example. In one example embodiment, the second rotating member may be a belt member similar to the fixing belt 51 that lies on members such as a driving roller while being stretched.

Moreover, although the connector 56 and the connector holder 57 may include respective parts separated from each other according to the example embodiment described above, the technology is not limited to this example. In one example embodiment, the parts may be integrated into a single part.

Moreover, although the plate-shaped heater 53 including a heat generating body such as a resistive wire as the heat source of the fixing device 105 according to the example embodiment described above, the technology is not limited to this example. In one example embodiment, a halogen lamp may be used as the heat source instead of the heater 53.

Moreover, the description has been given above of the example embodiment where the LED head having a light-emitting diode as a light source may be used as the exposure device; however, the technology is not limited thereto. In one example embodiment, an exposure device having any other light source such as a laser element may be provided.

Moreover, the description has been given above of the example embodiment of the image forming apparatus performing printing as a specific but non-limiting example of the “image forming apparatus” in one embodiment of the technology; however, this is non-limiting. For example, one embodiment of the technology may be applicable also to an image forming apparatus serving as a multi-function peripheral performing another operation such as scanning or faxing in addition to printing.

Furthermore, the technology encompasses any possible combination of some or all of the various embodiments and the modifications described herein and incorporated herein. It is possible to achieve at least the following configurations from the above-described example embodiments of the technology.

(1)
A fixing device including:
a first rotating member that extends in a first direction;
a second rotating member that extends in the first direction and applies pressure to the first rotating member approximately in a second direction, the second direction being orthogonal to the first direction;
a heating section that extends in the first direction and heats the first rotating member;
a supporting member that supports the heating section;
a connector that is coupled to the heating section and supplies electric power to the heating section; and
a holder that holds the connector, the holder being supported by the supporting member in a state of being movable in the first direction.
   (2)
The fixing device according to (1), in which
the first rotating member has an annular shape having an internal space, the internal space extending in the first direction,
the heating section includes a first surrounded part and a first exposed part, the first surrounded part being provided in the internal space, the first exposed part extending in the first direction and being present outside the first rotating member,
the supporting member includes a second surrounded part and a second exposed part, the second surrounded part being provided in the internal space, the second exposed part extending in the first direction and being present outside the first rotating member,
the connector is coupled to the first exposed part of the heating section, and
the holder holds the first exposed part and is supported by the second exposed part.
   (3)
The fixing device according to (2), in which
the holder includes an insertion part, the insertion part having a cavity that extends in the first direction, and
the second exposed part of the supporting member has a part that is in a state of being inserted in the cavity of the insertion part.
   (4)
The fixing device according to (3), in which the part, of the second exposed part, that is in the state of being inserted in the cavity has a size, on a cross-section orthogonal to the first direction, equal to or smaller than a size of the cavity.
   (5)
The fixing device according to (4), in which a dimension of the cavity in a cross-section orthogonal to the first direction and a dimension of the second exposed part in the cross-section are different from each other within a range from 0.1 millimeters to 0.4 millimeters both inclusive.
   (6)
The fixing device according to (3), in which the cavity fully extends through the insertion part in the first direction.
   (7)
The fixing device according to (1), in which the heating section is positioned in vicinity of a contact part at which the first rotating member and the second rotating member are in contact with each other.
   (8)
The fixing device according to (1), in which the heating section and the holder are fixed to each other at a single joint.
   (9)
The fixing device according to (8), in which the joint is positioned in vicinity of the connector.
   (10)
The fixing device according to (1), in which the heating section and the supporting member are fixed to each other at a single point in the first direction.
   (11)
The fixing device according to (1), in which the heating section and the supporting member are fixed to each other at a single point, in the first direction, that is positioned in middle of the first rotating member.
   (12)
The fixing device according to (1), in which the heating section includes a first heat generating body and a second heat generating body, the first heat generating body heating a middle part, of the first rotating member, in the first direction, the second heat generating body heating both end parts, of the first rotating member, in the first direction.
   (13)
The fixing device according to (12), in which the first heat generating body and the second heat generating body are separated away from each other in a direction orthogonal to both of the first direction and the second direction.
   (14)
The fixing device according to (12), in which the connector includes a first coupling part and a second coupling part, the first coupling part being to be coupled to the first heat generating body, the second coupling part being to be coupled to the second heat generating body.
   (15)
The fixing device according to (1), in which the supporting member has rigidity higher than rigidity of the heating section.
   (16)
The fixing device according to (1), in which the supporting member supports the first rotating member in a rotatable state.
   (17)
The fixing device according to (1), further including a heater holder, the heater holder extending in the first direction and being positioned between the heating section and the supporting member, the heater holder holding the heating section.
   (18)
An image forming apparatus including:
a medium feeding section;
an image forming section; and
the fixing device according to (1).

According to the fixing device of the embodiment of the technology, electric power is fed stably to the heating section. This makes it possible to achieve more stable operation.

According to the image forming apparatus including the fixing device, it is therefore possible to form a high-quality image.

Note that these are mere examples of effects of the technology. The effects of the technology are not limited thereto and may include any of the effects described above.

Although the technology has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. A fixing device comprising:
a first rotating member that extends in a first direction;
a second rotating member that extends in the first direction and applies pressure to the first rotating member approximately in a second direction, the second direction being orthogonal to the first direction;
a heating section that extends in the first direction and heats the first rotating member;
a supporting member that supports the heating section;
a connector that is coupled to the heating section and supplies electric power to the heating section; and
a holder that holds the connector, the holder being supported by the supporting member in a state of being movable in the first direction.

2. The fixing device according to claim 1, wherein
the first rotating member has an annular shape having an internal space, the internal space extending in the first direction,
the heating section includes a first surrounded part and a first exposed part, the first surrounded part being provided in the internal space, the first exposed part extending in the first direction and being present outside the first rotating member,
the supporting member includes a second surrounded part and a second exposed part, the second surrounded part being provided in the internal space, the second exposed part extending in the first direction and being present outside the first rotating member,
the connector is coupled to the first exposed part of the heating section, and
the holder holds the first exposed part and is supported by the second exposed part.

3. The fixing device according to claim 2, wherein
the holder includes an insertion part, the insertion part having a cavity that extends in the first direction, and
the second exposed part of the supporting member has a part that is in a state of being inserted in the cavity of the insertion part.

4. The fixing device according to claim 3, wherein the part, of the second exposed part, that is in the state of being inserted in the cavity has a size, on a cross-section orthogonal to the first direction, equal to or smaller than a size of the cavity.

5. The fixing device according to claim 4, wherein a dimension of the cavity in a cross-section orthogonal to the first direction and a dimension of the second exposed part in the cross-section are different from each other within a range from 0.1 millimeters to 0.4 millimeters both inclusive.

6. The fixing device according to claim 3, wherein the cavity fully extends through the insertion part in the first direction.

7. The fixing device according to claim 1, wherein the heating section is positioned in vicinity of a contact part at which the first rotating member and the second rotating member are in contact with each other.

8. The fixing device according to claim 1, wherein the heating section and the holder are fixed to each other at a single joint.

9. The fixing device according to claim 8, wherein the joint is positioned in vicinity of the connector.

10. The fixing device according to claim 1, wherein the heating section and the supporting member are fixed to each other at a single point in the first direction.

11. The fixing device according to claim 1, wherein the heating section and the supporting member are fixed to each other at a single point, in the first direction, that is positioned in middle of the first rotating member.

12. The fixing device according to claim 1, wherein the heating section includes a first heat generating body and a second heat generating body, the first heat generating body heating a middle part, of the first rotating member, in the first direction, the second heat generating body heating both end parts, of the first rotating member, in the first direction.

13. The fixing device according to claim 12, wherein the first heat generating body and the second heat generating body are separated away from each other in a direction orthogonal to both of the first direction and the second direction.

14. The fixing device according to claim 12, wherein the connector includes a first coupling part and a second coupling part, the first coupling part being to be coupled to the first heat generating body, the second coupling part being to be coupled to the second heat generating body.

15. The fixing device according to claim 1, wherein the supporting member has rigidity higher than rigidity of the heating section.

16. The fixing device according to claim 1, wherein the supporting member supports the first rotating member in a rotatable state.

17. The fixing device according to claim 1, further comprising a heater holder, the heater holder extending in the first direction and being positioned between the heating section and the supporting member, the heater holder holding the heating section.

18. An image forming apparatus comprising:
a medium feeding section;
an image forming section; and
the fixing device according to claim 1.
